(19) United States
(12) Patent Application Publication
(10) Pub. No.: US 2002/0077819 A1
(43) Pub. Date: Jun. 20, 2002

(54) Voice prompt transcriber and test system

(76) Inventor: Paul S. Girardo, Reading, MA (US)

Correspondence Address: STAAS & HALSEY LLP, 700 11TH STREET, NW, SUITE 500, WASHINGTON, DC, 20001, US

(21) Appl. No.: 09/739,749

(22) Filed: Dec. 20, 2000

(51) Int. Cl. G10L 13/08

(52) U.S. Cl. 704/260

(57) ABSTRACT

The invention is a system that records the prompts of a system being tested and compares them to expected prompts for the system. The prompts are recorded over a conventional telephone line. The recorded prompts are converted into text using a speech recognizer and a speech profile for the voice of the talent who recorded the prompts. The profile can be created from the system being tested by playing the prompts to the recognizer in a training operation in an order controlled by a training script that allows the recognizer to be exposed to enough words spoken by the talent to train the recognizer to recognize the voice of the talent. The text of the recorded prompts is compared to text for the expected prompts. The testing of the system is controlled by a system control script that navigates through a system prompt tree using commands that a user would use when using the system, as a result, the sequence as well as the wording of the prompts is tested. A report concerning whether the recorded prompts agree with the expected prompts is produced which includes the text of the recorded and expected prompts.

### BACKGROUND OF THE INVENTION

1. Field of the Invention

The present invention is directed to a Voice Prompt Transcriber and Test System (VPTT) that transcribes voice prompts from a voice based system with the text of the transcribed voice prompts being compared to expected prompt text enabling the system to determine if the correct prompts were played and, more particularly, to a system that uses a system test script to cause prompts to be played in an order, compares the prompts to the expected prompts and thereby tests both the wording of the prompts and the order of the prompts (or call flow) to see if they are correct.

2. Description of the Related Art

The number of systems that use voice prompts to assist a user in navigating through functions of the systems is growing each day. Examples are voice-mail systems, interactive response systems (IVR), etc. As a result, the need for automated methods of testing the prompts of such systems is increasing. What is needed are improved automated prompt testing systems.

Typical prompt comparison systems use proprietary software and compare the actual voice file waveform (.wav or vox or oki sound file format) to the recorded prompt file waveform. This is a waveform to waveform comparison.

Typical automated testing/verification systems for prompts and call flows require instrumentation of the application (e.g. replacing prompts with DTMF (dual tone multifrequency) tones, gathering log/trace information from the system, modifying the code for test purposes). What is needed is platform-independent testing/verification of voice prompts and call flow of a voice application without requiring instrumentation of the application.

Another problem is special hardware/telephones connections required for remote testing of voice based systems. What is needed is an ability to perform complete remote testing with only a simple POTS (plain old telephone service) connection on the user's end.

A further problem is the lack of a test tool that has the ability to test any voice prompts and call flow of the voice application on any voice system. What is needed is a system that enables the user to have the ability to test any voice prompts and any call flow of the voice application on any system (via speech recognition).

An additional problem is the lack of an ability to have an automated way to verify prompts recorded in an Audio Lab/Recording Studio for voice-mail/enhanced services systems. What is needed is a test tool which performs automated verification of recorded voice prompts right after they are recorded by the voice talent in the Audio Lab/Recording Studio.

### SUMMARY OF THE INVENTION

It is an aspect of the present invention to allow improved automated prompt testing systems.

It is another aspect of the present invention to allow prompt testing with simple equipment and procedures.

It is an additional aspect of the present invention to allow testing of an application that can be driven by “voice commands”, DTMF signals, other tones and other flow control signals.

It is an aspect of the present invention to allow testing of prompt based systems.

It is also an aspect of the present invention to allow testing of voice prompts and a call flow of a voice application.

It is a further aspect of the present invention to allow an automated way to verify prompts recorded in a studio.

The above aspects can be provided by a system that records the prompts of a system being tested and compares them to expected prompts for the system. The recorded prompts are converted into text using a speech recognizer with a speech profile for the voice of the talent who recorded the prompts. The text of the recorded prompts is compared to text for the expected response. The testing of the system is controlled by a script that navigates through a system prompt tree using commands that a user would use when using the system, as a result, the sequence as well as the wording of the prompts of the system are tested.

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts components of the present invention.

FIG. 2 shows the contents of a script database.

FIG. 3 shows the contents of a prompt to text mapping database.

FIG. 4 shows on-line training a speech recognizer from prompts of the prompt of a system to be tested.

FIG. 5 shows testing the prompts of a system for which a profile has been created on-line.

FIG. 6 shows off-line training of a recognizer with prompts in an archive.

FIG. 7 shows testing the prompts of a system for which a profile has been created off-line.

FIG. 8 shows on-line training a speech recognizer from prompts recorded in a studio.

FIG. 9 shows testing the prompts of a system for which a profile has been created from studio recordings.

FIG. 10 shows an example of a call flow/bubble chart for the voice prompts particularly for FIG. 2.

### DESCRIPTION OF THE PREFERRED EMBODIMENTS

The present invention is directed to a Voice Prompt Transcriber and Test System (VPTT) which utilizes continuous speech recognition to transcribe voice prompts from a voice-mail system (or any telecommunications system in which voice prompts are presented/played to the end user, such as an interactive voice response (IVR) system). The text of each transcribed voice prompt is then compared against the “expected prompt text” enabling the system to determine if the correct prompts were played. The “expected prompt text” is also stored in a database for the particular voice application and is available to the system for future tests.

The expected prompt text can be made available in a number of different ways. The expected prompt text can be: produced by system designers; written down and entered in a database when the prompts are recorded; or determined from an existing system by playing all the prompts of the existing system and converting them into text.

The present invention provides the ability to test any voice prompts and any call flow of a voice application on any voice system when the VPTT has a Speech Profile of the voice prompts where, for example, the VPTT has been trained to recognize voice prompts from the system under test (SUT). This training can also be performed completely remotely via recording of the prompts from the SUT (as conventional .wav files or other audio formats) by the VPTT and then building the Speech Profile from the recorded voice prompts. The VPTT also has the access number (phone number) of the SUT voice application allowing the VPTT to connect to the SUT remotely using conventional connection procedures. The VPTT has a “template” of the specific call flow to be tested on the SUT. A “template” includes a script (voice system commands, command sequence, etc), prompt IDs and their associated expected text, that are “played” for a particular test/call flow.

The Speech Profile can be created in a number of different ways. The Profile can be created by allowing the voice talent, who will record the system prompts, to conventionally speak a prescribed text used to teach the particular conventional speech recognition system being used in the system; or by teaching the speech recognition system using the prompts that have been recorded or stored within the system being designed or tested, that is, prompts from the system under test; or the system can be taught using prompts that have been stored in a prompt archive and which could be prompts for a number of different systems. By training using recorded prompts (recorded .wav files), the training can be independent of the physical location of the voice talent. The voice talent can be the voice of a person or the synthesized voice produced by a machine.

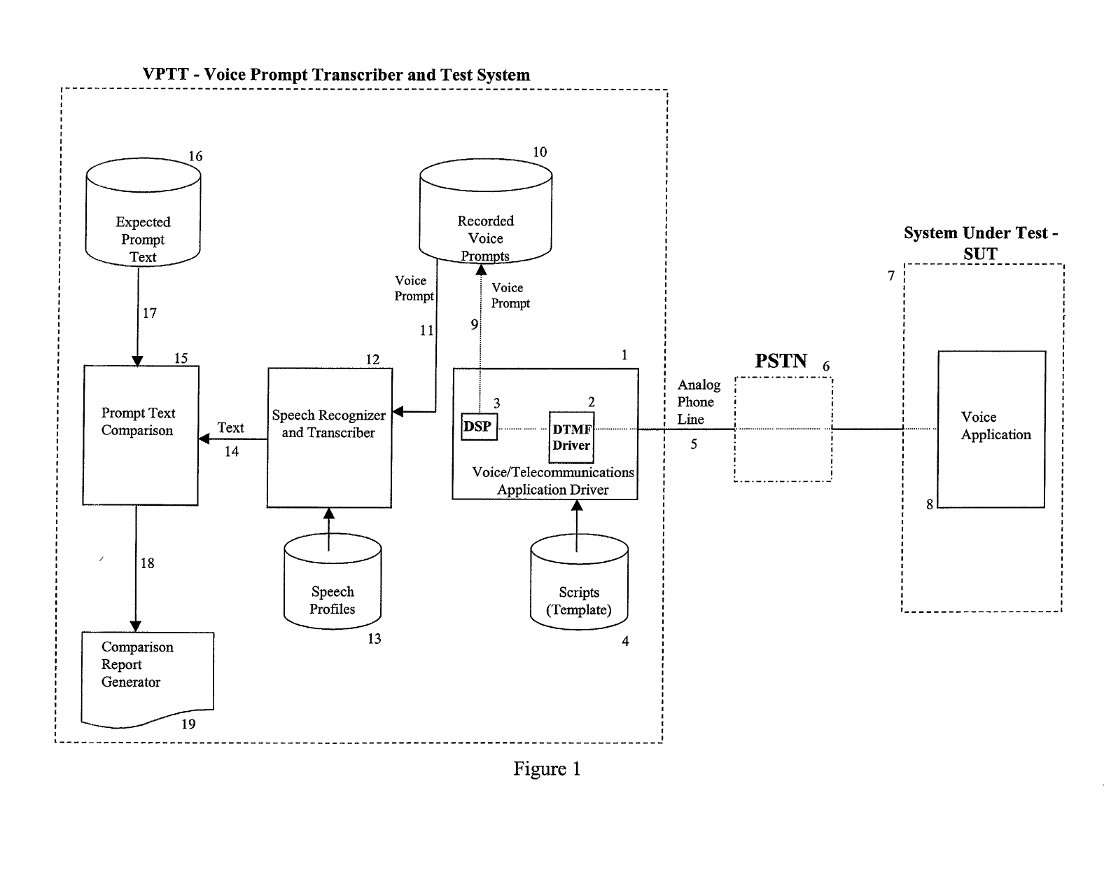

The VPTT (Voice Prompt Transcriber and Test System) of the present invention uses speech recognition to transcribe voice prompts into their corresponding text and then verifies whether the prompt matches the “expected prompt text”. FIG. 1 depicts the components of the VPTT system and telephony connections associated therewith. The VPTT system can be used to test various voice platforms and also can be used to validated prompts recorded in a sound lab/recording studio before the voice application is built.

Prior to discussing the details of the present invention several definitions will be provided: DTMF—Dual Tone Multi-Frequency; DSP—Digital Signal Processor; PSTN—Public (or Private) Switch Telephone Network; SUT—System Under Test (the voice based system the VPTT is testing which can be in the field and in actual use); Speech Profile—Files containing information about the “speaker” for the recognition engine where the Speech Profile is built from speech samples, language information and text, they are used by the speech recognition engine to identify and transcribe speech where these files are commonly called “User Speech Files” in the Speech Recognition industry; Telephony Commands—Commands used to drive the voice application (such as Off_Hook, Send_DTMF_{—}1, etc. where these are pseudo script command examples); Template—The information required to test the application and verify the Call Flow where a “template” is the scripts (telephony commands for playing the prompts), prompts IDs and their associated text, which are expected to be played for a particular test/call flow.

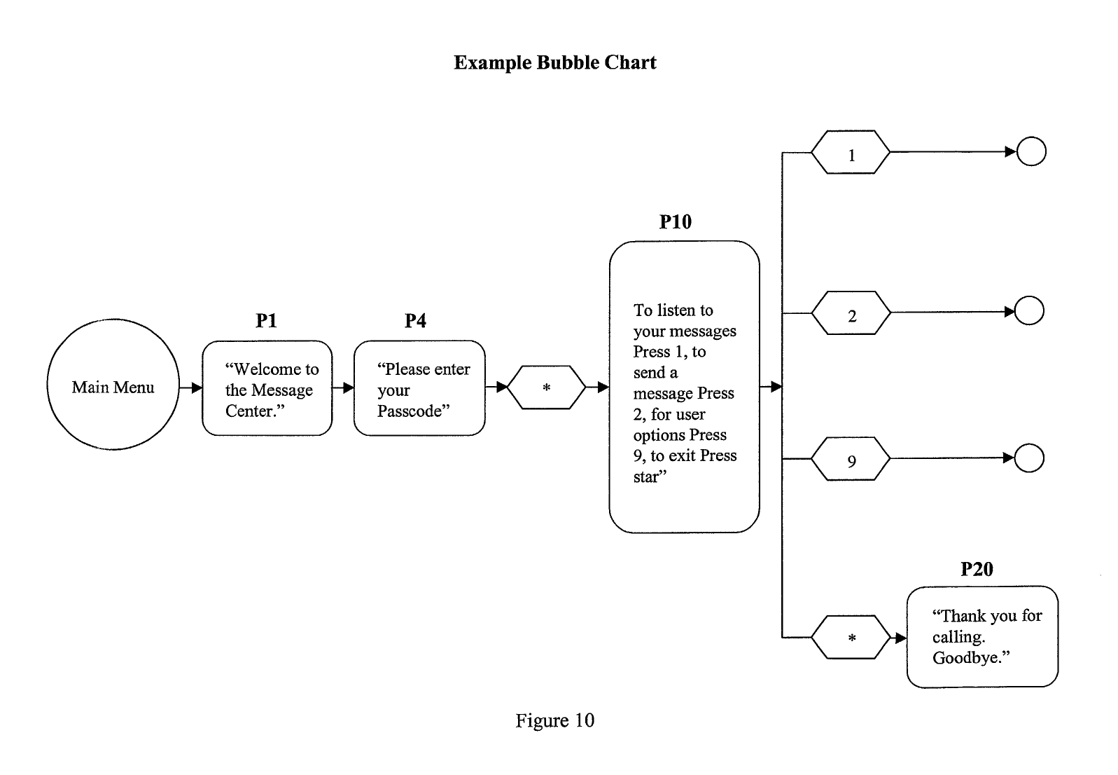

In a typical scenario where the prompts of a system are to be tested, a Speech Profile of the voice of the speaker of the prompts is created. The voice prompts are recorded and stored in the system along with the sequence of commands (typically a system script) that control the system to produce the prompts responsive to control signals from a user, such as DTMF tones, silence, etc. A system script is typically represented as a bubble chart (see FIG. 10). The text of the prompts is also recorded as expected prompt text. The system script can be used to create a test script. A test script includes simulated user control signals that corresponds to the system script and which will cause the system being tested to play the prompts stored in the system in a way that allows the call flow to be tested and the prompts to be tested. The system is tested using the test script to control the system, the prompts are recorded, converted to text and compared to the expected text. Once the system passes the test when future changes to the sequence of prompts is made, such as an original prompt sequence “Press 1 to mark the message urgent” is changed to a new prompt sequence “To mark the message urgent Press 1”. The three unique prompts in this example that make up the full prompt are “Press”, “1” and “to mark the message urgent”, a corresponding new test script can be used with the original expected text to determine whether the correct prompts are played at the proper time. When new prompts are recorded or substituted, such as when it is determined that a particular prompt is confusing and a new version is to be used, the system can again be tested using the original script and the new expected text.

A training script is a script that is used to control the system under test to obtain/record the prompts to allow the engine to be trained. The training script can be a version of the test script or some other script that will cause the system being tested to play enough prompts to be able to train the recognition engine.

As depicted in FIG. 1, the main components of the VPTT system, preferably embodied in a work station type computer, include a Voice/Telecommunications Application Driver 1 which controls the system under test (SUT) 7 to obtain the SUT prompts which are converted into text by a conventional Speech Recognizer and Transcriber 12, such as available from Dragon Systems of Massachusetts, USA. The text of the prompts is provided to a Prompt Text Comparator 15 where the prompt text is conventionally compared to expected prompt text using a text comparison system. These components will be described in more detail below.

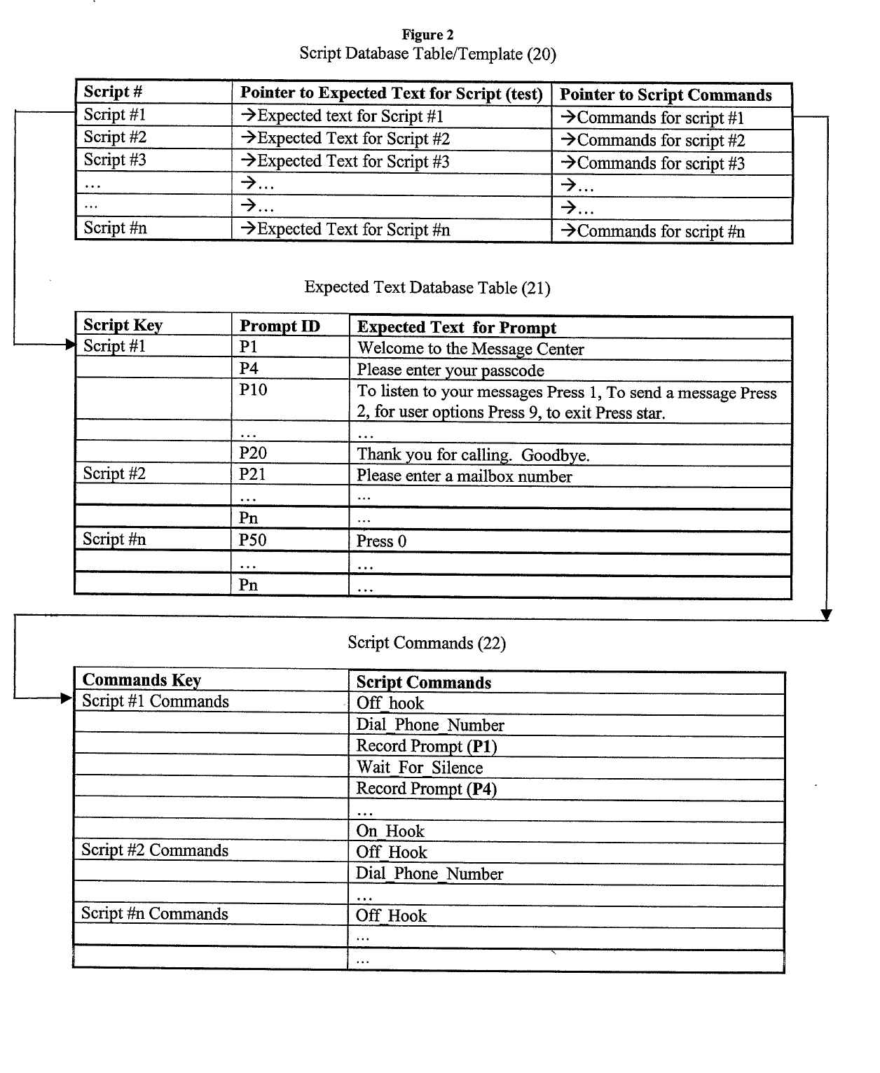

The Voice/Telecommunications Application Driver 1 includes a conventional method or process of connecting to the SUT 7 via an analog phone line 5 through a PSTN 6. The PSTN 6 can be a Public or Private Switched Telephone Network. A standard/conventional telephony board can be used for the analog connection. The Voice/Telecommunications Application Driver 1 includes a conventional method to drive the voice application on the SUT 7 to play the prompts therein. To initiate the connection and drive the application scripts/template 4 are used and which will be described in more detail later with respect to FIG. 2. Scripts are a collection of “commands” to connect, traverse and test the telephony voice menus in the application on the SUT 7. Common pseudo commands would be “Off-Hook”, “Dial”, “Send DTMF digit”, “Record Prompt”, “On-Hook”, etc.

The Voice/Telecommunications Application Driver 1 uses a conventional DTMF Driver 2 to interact with the voice application on the SUT 7. A conventional a DSP 3 is used to record the voice prompts when they are played on or by the SUT 7. The recording can be 8 KHz sampled voice files of typical analog telephone line type quality.

Voice Prompts that are recorded from the SUT 7 are stored 9 in the Recorded Voice Prompts database 10. Each Recorded Voice Prompt has a Prompt ID associated with it for later comparison/validation to determine if the prompt is correct. When the “test” scripts that causes the SUT 7 to play the prompts ends, the operation of the VPTT moves into the Speech Recognizer and Transcriber 12 component. The Speech Recognizer and Transcriber 12 first loads the correct Speech Profile 13 for the specific prompt “voice” in order to accurately transcribe the voice prompts. That is, the conventional speech profile of the voice of the person who recorded the prompts is loaded. The recorded Voice Prompts 10 from the SUT 7 are provided to or accessed by the Speech Recognizer 12 and transcribed into the corresponding text.

The transcribed text 14 with the associated Prompt ID is passed to the Prompt Text Comparison component 15. The Expected Prompt Text 16 is also passed to the Comparison component 15 and the Transcribed Text 14 is conventionally compared to the Expected Prompt Text 16. The expected text 16 is keyed on or identified for the particular test script/template 4 that has been run. The Prompt Text Comparison component 15 determines if the transcribed text is correct and a report 19 is generated 18 when all the voice prompts from the “test” have been transcribed and compared. The comparison preferably ignores capitalization, punctuation, etc. which may be included in the expected prompt text so that only the text is compared.

The Script 4 shown in FIG. 1 includes several tables 20, 21 and 22 as depicted in FIG. 2. A Database Table/Template 20 as shown in FIG. 2 is used for the actual driving and testing of the voice application. The Table/Template 20 includes a script key number (Script #1) which is the number of the system control script in the Script Database. A single script typically causes several prompts to be recorded. The Database Table/Template 20 also includes a Pointer to Script Commands which is a pointer to the list of telephony commands (script) that are used to exercise a specific Call Flow path (prompts) in the application under test in the System Under Test (SUT). Also included is a Pointer to Expected Text for Script (test) for the specified test (Call Flow/Prompts) that should match the prompt output of the application when the test script is executed.

The Script 4 includes the Expected Prompt Text Database Table 21 (see FIG. 2). This Table 21 is used to determine what the text of the prompt is for a given Prompt ID. This Table 21 contains a Script Key number which corresponds to the test script number with which the Prompts are associated. A Prompt ID is provided which is a number used to identify the specific prompt, e.g. P12. This table also includes the Expected Text for Prompt which is the text for specified prompt (e.g. “Welcome to the Message Center” corresponds to Prompt ID P1).

The Script 4 includes a table of Scripts Commands 22 which, as shown in FIG. 2, includes a Commands Key which identifies the script commands and the particular Script Commands. The commands allow the SUT to be navigated through the prompt tree of the system (see FIG. 10 for a bubble chart corresponding to script #1 of FIG. 2) to produce the prompts of the SUT in an order that a user of the system might use the system, and thereby encounter all of the prompts of the SUT. The script allows all of the prompts of the SUT to be recorded.

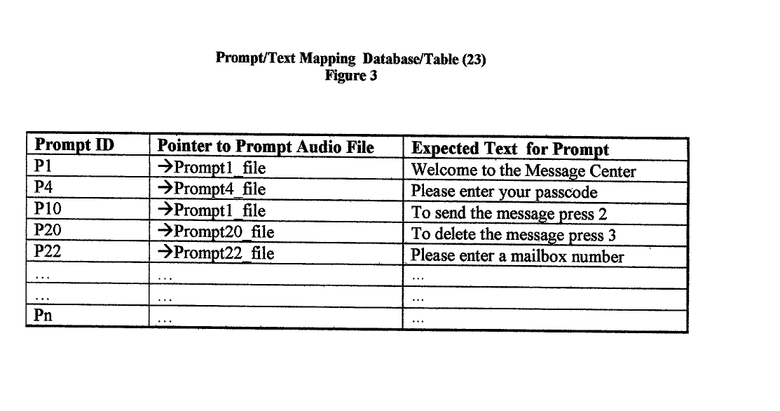

A Prompt/Text Mapping Database/Table 23 as shown in FIG. 3 is used for determining the correct prompt and prompt text for the given Prompt ID during the Audio Lab testing function of the VPTT. This Table contains a the Prompt ID (a number to identify the specific prompt, e.g. P12), a Pointer to Prompt Audio File which is a pointer to the physical prompt file and the Expected Text for Prompt the specified prompt ID.

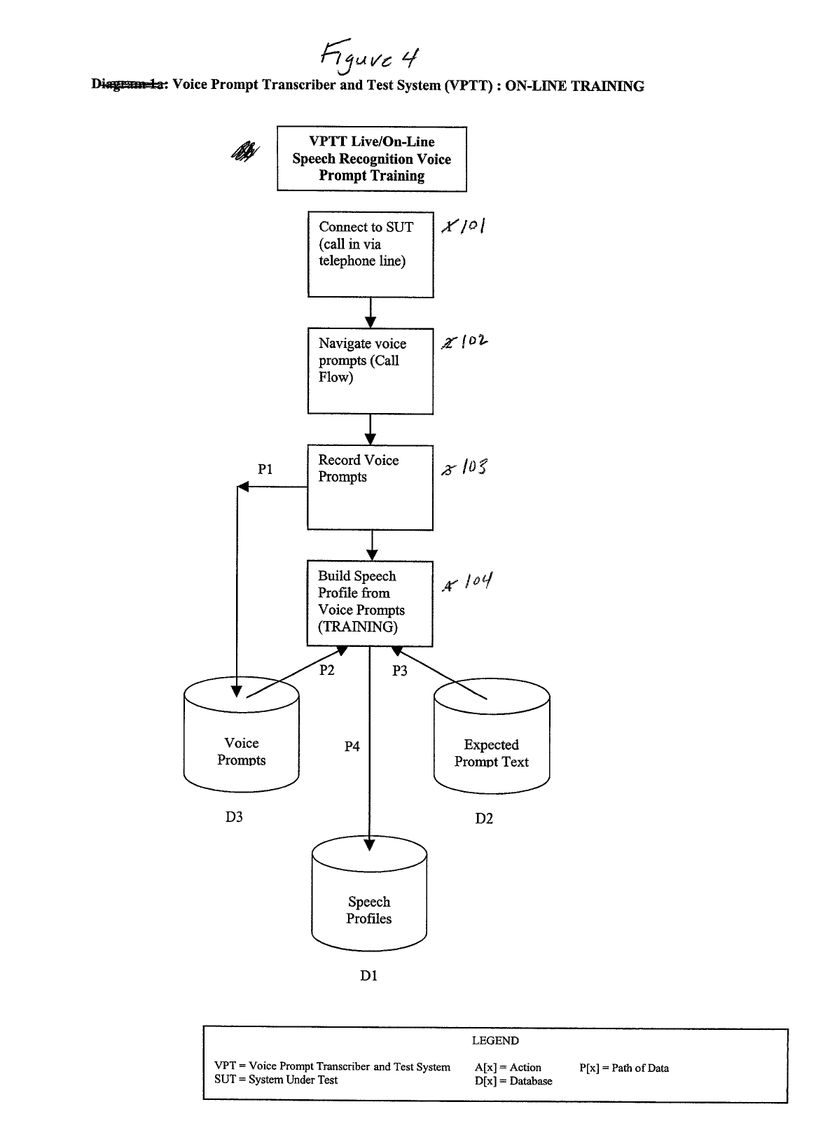

Several examples will be discussed below with respect to FIGS. 4-9 where the system of the invention is used to test prompts of a voice based system.

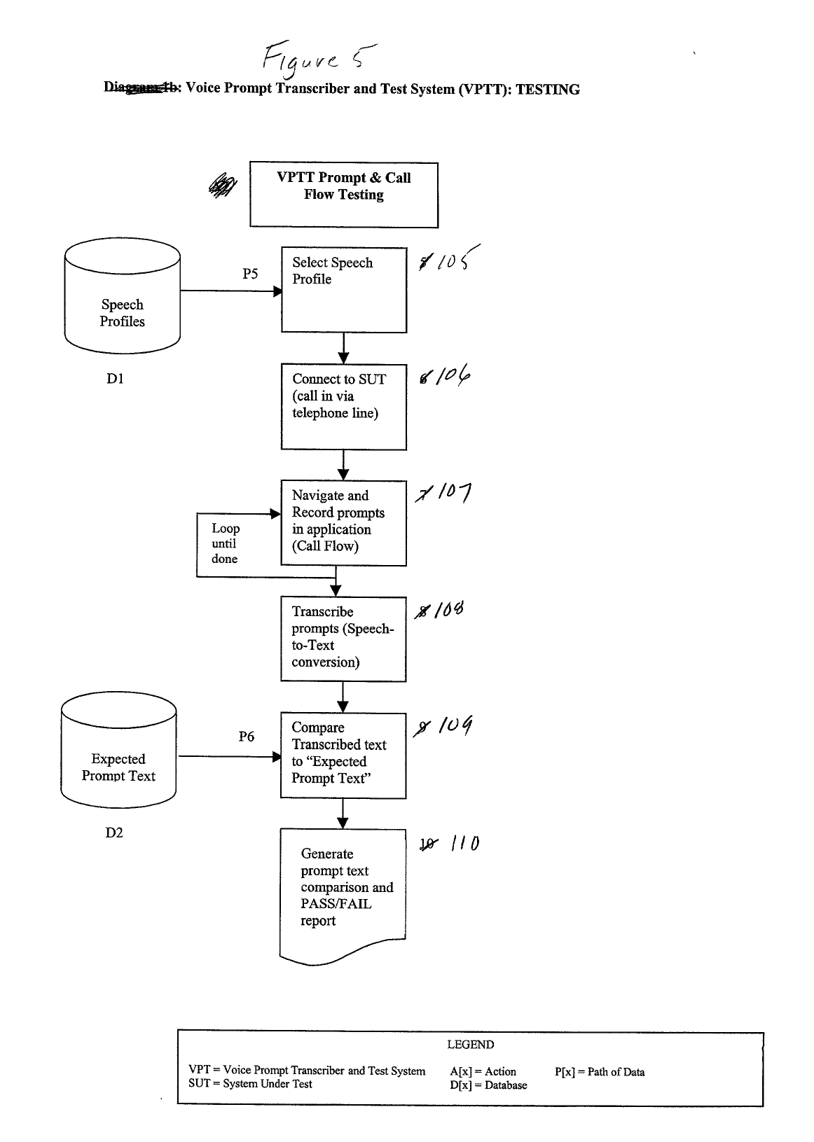

In the example of FIGS. 4 and 5, the job is to verify the call flow (flow of the prompts) of a new voice based system in which no Speech Profile is currently available and where the VPTT does not have access to a voice prompt database/archive and Speech Profile training is on-line. The first task (see FIG. 4) is to train the speech engine 12, from the voice prompts recorded from the System Under Test (SUT) 7, and create a Speech Profile 13 before the testing of the voice application can proceed. Once the training is completed the user/tester can proceed to testing the SUT 7. The second task (see FIG. 5) is to use the VPTT to connect to the SUT and test/verify if the Call Flow is correct. This step is invoked by the user/tester.

The first operation in the first task is to connect 101 to the SUT by placing a telephone call into the SUT via an analog phone line (see FIG. 4). Next, the system navigates 102 a predefined call flow path through the voice prompts in the voice application by generating appropriate tones, awaiting the playing of the prompt, etc. For example, the system could, based on a script, command the driver 1 to go off hook, dial the telephone number, wait for an off-hook of the SUT, record the prompt while waiting for silence, play a DTMF tone to select a branch of the prompt tree, record the prompt while waiting for silence, play another DTMF tone to select another tree branch, etc. This can be performed automatically by a conventional tone generation device (e.g. a Hammer system available from Hammer Technologies of Massachusetts) using a training script as previously described or manually by the user. The training script can be a script that causes the prompts to be played in an arbitrary order, or it more preferably is a version of a system test script. The system records 103 the voice prompts played by the SUT 7 and stores the recorded voice prompts in the Voice Prompts database D3 (see Path P1). A minimum of 20 minutes of prompts typically needs to be recorded for the speech engine 12 to build an accurate Speech Profile of the voice of the talent speaking the voice prompts.

Speech engine 12 training is invoked automatically after the required prompts are recorded. Building 104 the Speech Profile stored in database D1 (see Path P4) is performed using the contents of the recorded Voice Prompts database D3 (see Path P2) and the contents of Expected Prompt Text database D2 (see Path P3). These two inputs are fed into the speech engine 15 to conventionally form the basis of the Speech Profile for the SUT 7. The Speech Profile (D1) will be used to transcribe the prompts from the SUT 7 into text for comparison/validation. At this point the VPTT is ready to perform Prompt and Call Flow testing on the SUT 7.

In performing prompt and call flow testing, the correct Speech Profile from the database D1 (see Path P5) must be selected for the SUT 7 (see FIG. 5). In this case it will be the Speech Profile that was built from the voice prompts that are used in the voice application on the SUT 7. Once the correct profile is selected the system connects 106 to the SUT 7, via an analog telephone line. Similar to the previous situation, the system navigates 107 through the SUT 7 prompts and records the prompts from the voice application for the Call Flow until all of the prompts are recorded. Again navigation can be performed automatically using a tone/DTMF generation device (e.g. Hammer) or similar device/software utilizing a system control script of telephony commands. Recording of the prompts is done by the VPTT (e.g. using the specific telephony hardware/DSP). The recorded prompts played from the SUT 7 will reside on the workstation type computer where VPTT is being executed. Navigation and recording of prompts (driven by the scripts) is performed in a loop until the test is completed. The system then transcribes 108 the recorded voice prompts (conventional Speech-To-Text conversion) into corresponding text. The recording of the voice prompts is preferably done for all the voice prompts during the navigation (test) of the voice application on-line. The transcription (Speech-To-Text) of all the recorded voice prompts is then preferably performed in batch mode. The VPTT then compares 109 the transcribed text of the recorded prompts from the SUT with the Expected Prompt Text stored in the Expected Prompt Text database D2 (see Path P6) for each prompt in the call flow. Note that the contents of the database D2 shown ion FIG. 5 will typically be different from the prompts used to train the system. For example, the training can be done with a prompt set that covers the prompts for a number of different in-field systems while the SUT may only include a part of the complete set of prompts. Once the comparison is performed a report is generated 110 for the transcribed voice prompt text and the expected prompt text where the report preferably includes a PASS/FAIL indication for each comparison along with the corresponding text from the transcribed prompt and expected prompt text allowing a reviewer of the report to determine what type of error occurred, if any.

Because of the varying characteristics of the SUTs, the quality of the prompts recordings, etc., it is possible for the transcription and comparison to fail when in actuality the prompt is correct. As a result, it is preferred that when a transcription and comparison of a prompt fails, that the speech-to-text conversion (transcription) and comparison operations for the failed recorded prompt be repeated with the maximum number of repeats being preferably about 5-10 times.

In this next example the user/VPTT task is to verify the call flow (flow of the prompts) of a new system in which no Speech Profile is currently available and the tester does have access to the voice prompt database/archive for the given SUT 7 and system training is done off-line. The task is to train the speech engine directly from the prompt archive of the SUT 7 and create a Speech Profile before testing of the voice application can proceed. Once the training is completed the user/tester can proceed to testing the SUT 7 where the second task is to connect to the SUT 7 and test/verify if the Call Flow is correct.

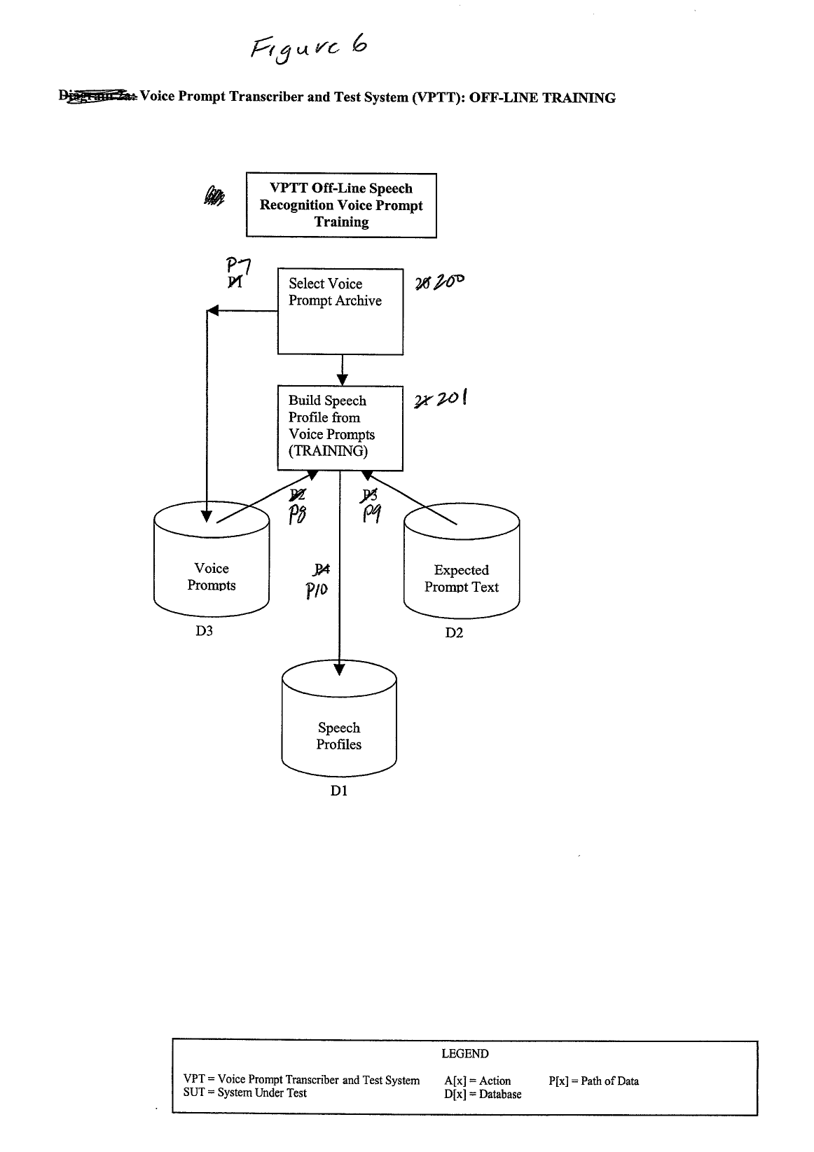

During training, as depicted in FIG. 6, the user first selects 200 the correct Voice Prompt Archive, which is used for the voice application running on the target SUT 7, from the Voice Prompts database D3 (see Path P7). Speech engine training involves building 201 the Speech Profile from the Voice Prompts database D3 (see Path P8) archive selected previously and from the contents of the Expected Prompt Text database D2 (see Path P9). This operation is invoked automatically after the required prompts archive is selected and these two inputs are used to form/create the Speech Profile for the SUT 7. The Profile is stored in Speech Profile database D1 (see Path P10) and will be used by the Speech Engine/Speech-To-Text transcriber to transcribe the prompts from the SUT 7 into text for comparison/validation. At this point the VPTT is ready to perform Prompt and Call Flow testing on the SUT 7.

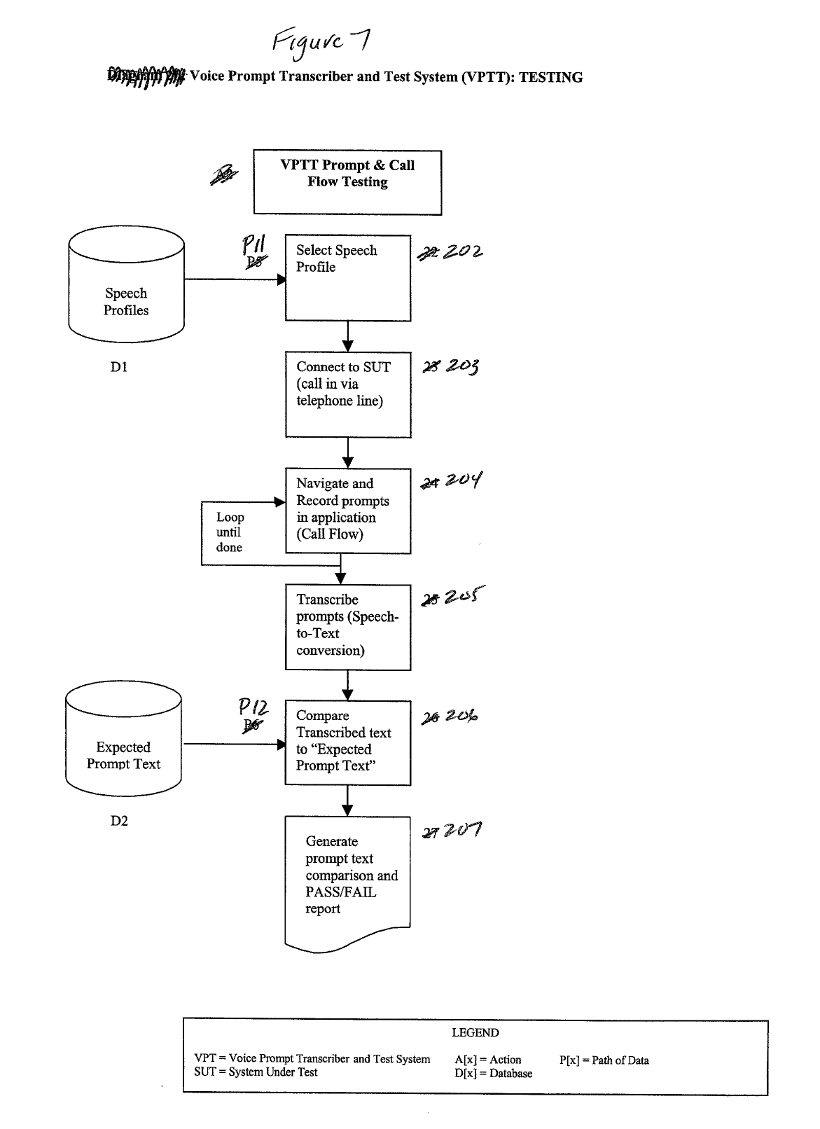

During the platform independent prompt and call flow testing the Speech Profile is selected 202 from the Speech Profiles database D1 (see Path P1) for the SUT 7 as shown in FIG. 7. In this case it will be the Speech Profile that was built from the voice prompts that are used in the voice application on the SUT 7. Next, the system connects 203 to the SUT 7, via an analog telephone line, navigates 204 through the prompt tree and records the prompts from the voice application for the Call Flow which is being tested. Navigation is performed automatically by a tone/DTMF generation device (e.g. Hammer) or similar device/software utilizing a script of telephony commands as previously discussed. Recording of the prompts is done automatically by the VPTT (e.g. using the specific telephony hardware/DSP). The recorded prompts played from the SUT 7 are stored on the computer where VPTT is being executed. Navigation and recording of prompts (driven by the scripts) is performed in a loop until the test is completed. Next, the record voice prompts played by the SUT are transcribed 205 (conventional Speech-To-Text conversion). The recording of the voice prompts is again preferably performed on-line for all the voice prompts during the navigation (test) of the voice application. The transcription (Speech-To-Text) of all the recorded voice prompts are then performed in batch mode before the comparison 206. In the comparison 206, the transcribed text of the recorded prompts from the SUT 7 is compared with the Expected Prompt Text in the Expected Prompt Text database D2 (see Path P12) for the specific prompts in the call flow. Again a report is generated on the transcribed voice prompt text and the expected prompt text, with a PASS/FAIL indication output for each comparison along with the text from the transcribed prompt and expected prompt text.

As previously noted the present invention can also be used for verifying voice prompts in an Audio Lab/Recording Studio environment. In the example discussed hereinafter an Audio Engineer's task is to verify new prompts in which no Speech Profile is currently available for the voice talent (the person whose voice is used for the prompts). The first task is to train the speech engine directly from the new prompts being recorded in the Audio Lab/Recording Studio. The second task is to use the VPTT to verify whether the prompts recorded by the voice talent are correct (match the expected text).

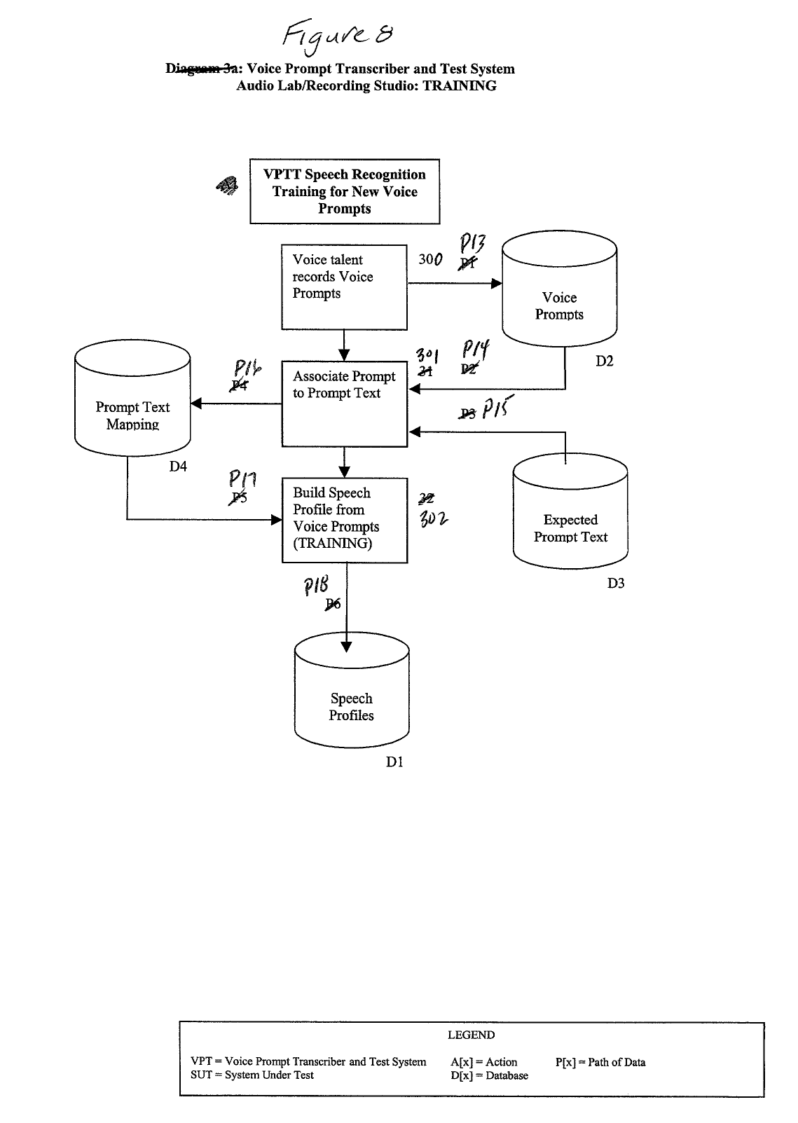

As depicted in FIG. 8, the voice talent (e.g. the person whose voice is used in the prompt recordings for the specified language) records 300 the voice prompts in the Audio Lab/Recording Studio. The prompts are then stored in the Voice Prompt database D2 (see Path P13). The recorded prompts in the Voice Prompt database D2 (see Path P14) are then associated 301 with the Expected Prompt Text in database D3 (see Path P15). A prompt ID is used to create an association between a prompt and its corresponding text (for example, Prompt ID 41=“Welcome to the Message Center”). The physical prompts (files) are preferably named with the Prompt ID. Therefore prompt file “41” will have the corresponding text “Welcome to the Message Center”. The Expected Prompt Text database D3 in this situation is typically maintained by the Audio Lab. The particular Prompt Text for each prompt is defined by System Engineering personnel for the system being designed. A pointer to the prompt and the prompt text is then stored in the Prompt Text Mapping Database D4 (see Path P16) shown in FIG. 3. The Speech Profile is then built 302 for the particular “project” (e.g. English, Spanish, Japanese, etc.). The Speech Profile is built from the voice prompts and prompt text contained in the Prompt/Text Mapping database D4 (see Path P17) and stored in the Speech Profiles Database D1 (see Path P18). If these are all new prompts, the entire Speech Profile will be built. If these are additional prompts that already have a Speech Profile defined, then the new prompts and expected prompt text are incorporated into the existing Speech Profile to fine tune the training.

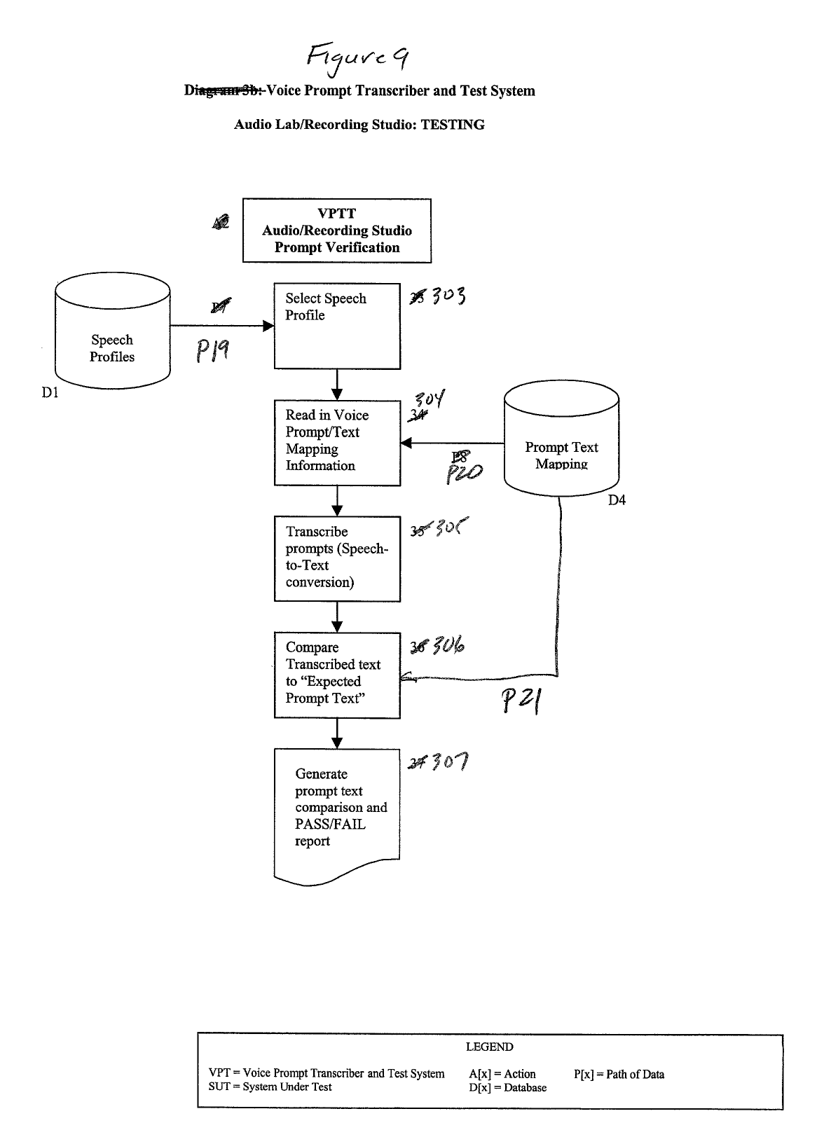

Once the prompts have been recorded and the profile created, the prompts can be tested as depicted in FIG. 9. First, the Speech Profile for the prompts to be tested is selected 303 from the Speech Profiles database D1 (see Path P19). Next, the system reads in Voice Prompt/Expected Text Mapping information from the Prompt/Text Mapping database D4 (Path P20). The system then transcribes 305 the prompts (conventional Speech-To-Text conversion) input from the Prompt Text Mapping database D4 (see path P21) for the selected Prompt/Text Mapping. The transcription (Speech-To-Text) of all the recorded voice prompts are preferably performed in batch mode. The system then compares 306 the transcribed text for the voice prompt to the Expected Prompt Text obtained using the Prompt/Text Mapping Information. As in previous situations, a report is generated on the comparison of the transcribed voice prompt text and the expected prompt text, and a PASS/FAIL indication is output for each comparison along with the text from the transcribed prompt and expected prompt text.

A traditional bubble chart corresponding to the script of FIG. 2 is depicted in FIG. 10. FIG. 10 shows four of the system prompts P1, P4, P10 and P20. As can be seen this prompt sequence when the system is accessed the two prompts P1 and P4 are played and the system expects or awaits, during the playing of the prompts P1 and P4, the input of a “*” DTMF after which the system will play the P10 prompt. As shown by the script #1 of FIG. 2, the system testing the prompts and verifying call flow would go off hook, dial the system telephone number, record prompt P1, wait or silence, record prompt P4, . . . . The recorded prompts would be compared to the expected prompts found in the expected text database table for script #1 in FIG. 2.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The present invention described herein compares the transcribed text to expected text. A text-to-text comparison is simpler and easier to quantify than waveform comparisons. The present invention also uses a proven/conventional speech recognition engine to perform the transcription, which results in a very high level of transcription accuracy. Also previous attempts at the prompt verification used English only software. The present invention because of the use of a conventional speech engines encompasses a variety of languages and lends itself to translation of the transcribed prompt text to other languages.

The present invention has been described as using text to perform the prompt comparison. The present invention can also use higher quality sampling for analysis of the voice prompts (22 KHz, 44.1 KHz) instead of the 8 Hkz typically used for conventional analog telephone lines. Of course the present invention can use custom/proprietary hardware for the telephony interface instead of off the shelf telephony boards. It is also possible to use custom/proprietary speech recognition software instead of off the shelf/commercially available conventional speech recognition software. The invention can use a digital phone line/direct T1 line to connect to the System Under Test instead of a standard analog line. The present invention has been described with respect to performing the conversion and comparison operations in batch mode. These operations can be performed in real-time. the present invention can also use post-recording and pre-transcription processing to improve accuracy such as filtering of “hiss”, etc.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A process, comprising:
inputting a spoken voice signal;
converting the spoken voice signal into spoken text; and
comparing the spoken text to expected text.

2. A process as recited in claim 1 where the spoken voice signal is a voice based system prompt.

3. A process as recited in claim 1, wherein said inputting is performed at an analog quality level.

4. A process as recited in claim 1, wherein said inputting is performed at an 8 KHz sampling rate.

5. A process as recited in claim 1, wherein said inputting comprises recording and storing a spoken prompt on-line and said converting and comparing are preformed in a batch mode.

6. A process as recited in claim 1, wherein the converting comprises performing speech to text conversion using a speech recognizer having a profile of the voice producing the spoken voice signal.

7. A process as recited in claim 6, wherein the voice comprises one of a person's voice and a machine's synthesized voice.

8. A process as recited in claim 1, wherein the inputting comprises:
accessing a system being tested via a telephone call to the system;
controlling the system using a system control script including a prompt identifier for prompts played; and
recording a system spoken voice prompt corresponding to the prompt identifier.

9. A process as recited in claim 8, wherein the controlling produces one of DTMF commands and voice commands supplied to the system.

10. A process as recited in claim 1, further creating a voice recognizer speech profile from the spoken voice signal.

11. A process as recited in claim 10, wherein the speech signal is obtained from existing voice system voice prompts.

12. A process as recited in claim 8, wherein the expected text has a prompt identifier and said comparing comprises:
obtaining expected text using the prompt identifier; and
comparing the spoken text to the expected text.

13. A process as recited in claim 1, wherein a test result indicates testing results of one of call flow verification and prompt verification.

14. A voice mail system prompt test process, comprising:
accessing a voice mail system over a telephone line;
playing and recording all voice mail system prompts of the voice mail system using a training control script;
training a speech recognizer using recorded training prompts and producing a speech profile;
playing and recording voice mail system prompts using a system control script;
converting recorded system prompts into text system prompts;
determining a prompt that should have been played for each of the recorded system prompts;
comparing the text system prompts to expected text prompts responsive to the determining; and
indicating whether each of the text system prompts corresponds to the prompt that should have been played.

15. An apparatus, comprising:
a voice based system having voice prompts and a call flow to be tested;
a telephone line connected to the voice based system; and
a test system causing the voice based system to play the prompts, converting the prompts to system prompt text and comparing the system prompt text to expected prompt text.

16. A computer readable storage controlling a computer by converting a spoken prompt into text and comparing the text to expected prompt text.
